(19) United States
(12) Patent Application Publication
(10) Pub. No.: US 2015/0261147 A1
(43) Pub. Date: Sep. 17, 2015

(54) FIXING DEVICE AND IMAGE FORMING APPARATUS

(71) Applicants: Yuji ARAI, Kanagawa (JP); Hideo NAGAFUJI, Kanagawa (JP); Kohichi UTSUNOMIYA, Kanagawa (JP); Arinobu YOSHIURA, Kanagawa (JP); Shohei SAITO, Kanagawa (JP); Qifeng CUI, Tokyo (JP); Yutaka IKEBUCHI, Kanagawa (JP); Motoyoshi YAMANO, Tokyo (JP)

(72) Inventors: Yuji ARAI, Kanagawa (JP); Hideo NAGAFUJI, Kanagawa (JP); Kohichi UTSUNOMIYA, Kanagawa (JP); Arinobu YOSHIURA, Kanagawa (JP); Shohei SAITO, Kanagawa (JP); Qifeng CUI, Tokyo (JP); Yutaka IKEBUCHI, Kanagawa (JP); Motoyoshi YAMANO, Tokyo (JP)

(21) Appl. No.: 14/657,406

(22) Filed: Mar. 13, 2015

(30) Foreign Application Priority Data
Mar. 14, 2014 (JP) 2014-052084

(51) Int. Cl. G03G 15/20

(52) U.S. Cl. CPC G03G 15/2017

(57) ABSTRACT

A fixing device includes a fixing member configured to be revolvable while being heated by a heat source; a counter rotator configured to form a nip between the fixing member and the counter rotator by applying a pressure to the fixing member in a contact state with the fixing member; a shield member disposed inside the fixing member to partially shield heat from the heat source; and a holding member attached to an end of the fixing member. The shield member includes a spacer configured to define a clearance to allow the holding member to be inserted into the fixing member from an end of the fixing member, the clearance being between the shield member and an inner surface of the end of the fixing member.

### CROSS-REFERENCE TO RELATED APPLICATION

The present application claims priority to and incorporates by reference the entire contents of Japanese Patent Application No. 2014-052084 filed in Japan on Mar. 14, 2014.

### BACKGROUND OF THE INVENTION

1. Field of the Invention

The present invention relates generally to a fixing devices and an image forming apparatuses.

2. Description of the Related Art

As is known, an electrophotographic image forming apparatus generally produces a reproduction output in the following manner. An electrostatic latent image formed on a photoconductor serving as a latent-image bearer is processed into a visible image with toner. The toner image is transferred to a sheet of a recording medium, such as recording paper, and thereafter fixed.

A fixing scheme using a thermal roller is well known as a fixing scheme employed in image forming apparatuses.

In this scheme, a toner image is fixed by applying heat and a pressure to the toner image using a fixing roller and a pressing roller contacting each other while facing each other with a recording-paper conveying path therebetween. The heat is applied from a heat source disposed in the fixing roller. The pressure is applied by pinching the toner image between the fixing roller and the pressing roller.

The fixing scheme using a thermal roller requires, due to a large heat capacity of the roller, warm-up time until the temperature of the roller reaches a fixing temperature.

Known schemes for reducing the warm-up time required to reach the fixing temperature include a belt fixing scheme that uses a belt whose heat capacity is smaller than that of the roller. An example of this scheme disclosed in Japanese Laid-open Patent Application No. 2004-286922 is implemented with a configuration in which a belt is heated at a position other than a nip area. Another fixing scheme what is referred to as “SURF (surface rapid fixing)” is also known. In this scheme, a nip-area portion of a belt facing a pressing roller is directed heated using a ceramic heater disposed on backside of the belt. An example of this scheme is disclosed in Japanese Patent No. 2861280.

There is a desire for a fixing device to reduce warm-up time required to reach the fixing temperature at which printing can be performed and to reduce first print time, which is time from start of the printing to ejection of recording paper on which an image is fixed. There is also a desire for the fixing device to prevent shortage in the amount of heat at start of continuous printing resulting from heat loss, which can occur when the number of sheets supplied to the fixing device per unit time increases.

To respond to these desires, the belt fixing scheme described above has become widely used. However, if the belt fixing scheme employs such a configuration as that described above in which the belt is locally heated, further reduction in first print time may not be attained. The reason therefor is as follows. When the belt is locally heated, the temperature of the belt is relatively low at not-heated portions in such a manner that the temperature of the belt is lowest at a portion at which the belt starts contacting recording paper in the nip area. This can result in faulty fixing. In particular, in an image forming apparatus that performs high-speed printing, revolving velocity of the belt is high, and therefore a large amount of heat is radiated from the belt at portions other than the nip area. Accordingly, in many cases, the temperature of the belt is low at a portion which is entering the nip area.

A technique implemented with a configuration in which the belt is heated across its entire width area, including the nip area, along a revolving direction of the belt to alleviate the disadvantage described above is proposed. An example of such a technique is disclosed in Japanese Laid-open Patent Application No. 2007-334205.

An example of this configuration that heats the entire belt is illustrated in FIG. 10.

A pipe-shaped metal thermal conductor 200 is arranged inside an endless belt 101. A heat source 300 is arranged inside the metal thermal conductor 200.

A pressing roller 400 for forming a nip area N is arranged to face the metal thermal conductor 200 in contact therewith. Recording paper can be conveyed by being pinched at the nip area N.

In this configuration, the endless belt 101 is revolved by rotation of the pressing roller 400. At this time, the metal thermal conductor 200 guides revolving of the endless belt 101. Heat radiated from the metal thermal conductor 200 heated by the heat source 300 inside the metal thermal conductor 200 can heat the entire width of the endless belt 101 along its revolving direction. Accordingly, this configuration allows not only reducing first print time from a not-yet-heated standby state but also preventing shortage in the amount of heat at high-speed revolving.

Meanwhile, there is a desire for further reduction in warm-up time and first print time even in the configuration in which the belt is heated across its entire width, including the nip area, along the revolving direction of the belt. As a configuration for at least partially satisfying this desire, a technique implemented with a configuration not including the metal thermal conductor 200 is proposed. An example of such a technique is disclosed in Japanese Laid-open Patent Application No. 2013-164473.

According to this technique, because heat radiated from a heat source directly heats an endless belt, a shield member providing a heat shield function is arranged to face the endless belt. The heat shield function prevents an excessive temperature rise in an area in a sheet width direction where a sheet is not conveyed (hereinafter, “non-sheet conveying area”) because of a sheet size or the like.

In the configuration using an endless belt, assembling onto the endless belt is performed through the procedure which will be described later with reference to in (a) to (e) in FIG. 11, for example. In FIG. 11, the endless belt is denoted by A for convenience. However, a first holding member B and a second holding member B′ inserted into the endless belt A from opposite ends thereof can damage edges of the endless belt A.

As indicated by reference symbol B′ in (b) in FIG. 12, each of the first and second holding members B and B′ is a member supporting the endless belt A while preventing meandering of the endless belt A and, simultaneously, supporting various members, including a heat source C1 and a stay C2, arranged inside the endless belt A. The stay C2 illustrated in (a) FIG. 12 is a nip forming member. In (a) to (e) in FIG. 11, the various members are collectively indicated by reference symbol C.

The assembly procedure is described below with reference to FIG. 11. The various members C to be arranged on axially opposite ends of the endless belt A or inside the endless belt A are mounted on the first holding member B that supports the various members C ((a) and (b) in FIG. 11).

When the various members C have been mounted on the first holding member B on one of the axially opposite ends of the endless belt A, the endless belt A is inserted to the first holding member B. Thereafter, the second holding member B′ is mounted on the other axially opposite end of the endless belt A ((c) to (e) in FIG. 11).

As illustrated in (a) in FIG. 13, the second holding member B′ is mounted on the end of the endless belt A on the internal side of which a shield member D is arranged. Accordingly, as illustrated in (b) in FIG. 13, the first holding member B can contact the end of the endless belt A. As a result, the end of the endless belt A can be damaged.

As illustrated in (b) in FIG. 12, the holding member D is mounted on the end of the endless belt A. More specifically, the holding member D is inserted to inside the endless belt A in a state where the shield member D is in contact with the internal side of the endless belt A as illustrated in (b) in FIG. 13. As a result, a small clearance δ is provided between the endless belt A and the shield member D as illustrated in (b) in FIG. 12. Reference symbol H in (a) in FIG. 12 denotes a reflection member which reflects heat radiated from a heat source toward the fixing belt A on the side opposite from a nip area.

If the endless belt A is in contact with a surface of the shield member D as illustrated in (b) in FIG. 13 when the holding member D is inserted to the end of the endless belt A, a clearance that allows insertion of the holding member B is not defined or small. As a result, the holding member B comes into contact with the end of the endless belt A. This contact can cause damage, such as a crack or deformation, to the end of the endless belt A.

FIG. 14 illustrates a state where the second holding member B′ illustrated in FIG. 11 is not inserted to the end of the endless belt A yet (corresponding to the state illustrated in (d) in FIG. 11). FIG. 15 illustrates a state where the second holding member B′ is inserted to the end of the endless belt A (corresponding to the state illustrated in (e) in FIG. 11).

There is a need for a fixing device configured to prevent or at least lessen a damage given to a fixing member when mounting a holding member which supports the fixing member onto the fixing member and an image forming apparatus employing the fixing device.

### SUMMARY OF THE INVENTION

It is an object of the present invention to at least partially solve the problems in the conventional technology.

According to an embodiment, there is provided a fixing device that includes a fixing member configured to be revolvable while being heated by a heat source; a counter rotator configured to form a nip between the fixing member and the counter rotator by applying a pressure to the fixing member in a contact state with the fixing member; a shield member disposed inside the fixing member to partially shield heat from the heat source; and a holding member attached to an end of the fixing member. The shield member includes a spacer configured to define a clearance to allow the holding member to be inserted into the fixing member from an end of the fixing member, the clearance being between the shield member and an inner surface of the end of the fixing member.

According to another embodiment, there is provided a fixing device that includes a fixing member configured to be revolvable while being heated by a heat source; a counter rotator configured to form a nip between the fixing member and the counter rotator by applying a pressure to the fixing member in a contact state with the fixing member; a shield member disposed inside the fixing member to partially shield heat from the heat source; and a holding member attached to an end of the fixing member. An edge of the shield member closer to the end of the fixing member is shifted from an edge of the end of the fixing member in a longitudinal direction of the fixing member.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram for describing an example configuration of an image forming apparatus employing a fixing device according to an embodiment of the present invention;

FIG. 2 is a schematic diagram for describing a configuration of the fixing device illustrated in FIG. 1;

FIG. 3 is a plan view of a shield member used in the fixing device illustrated in FIG. 2;

FIGS. 4 to 6 illustrate examples of the shield member used in the fixing device illustrated in FIG. 2 and a mounted state of a fixing member;

FIGS. 7 and 8 illustrate examples of end portions of the shield member and the fixing member used in the fixing device illustrated in FIG. 2;

FIG. 9 illustrates another example of the shield member illustrated in FIG. 3;

FIG. 10 illustrates a conventional example of a configuration which uses a belt as a fixing member;

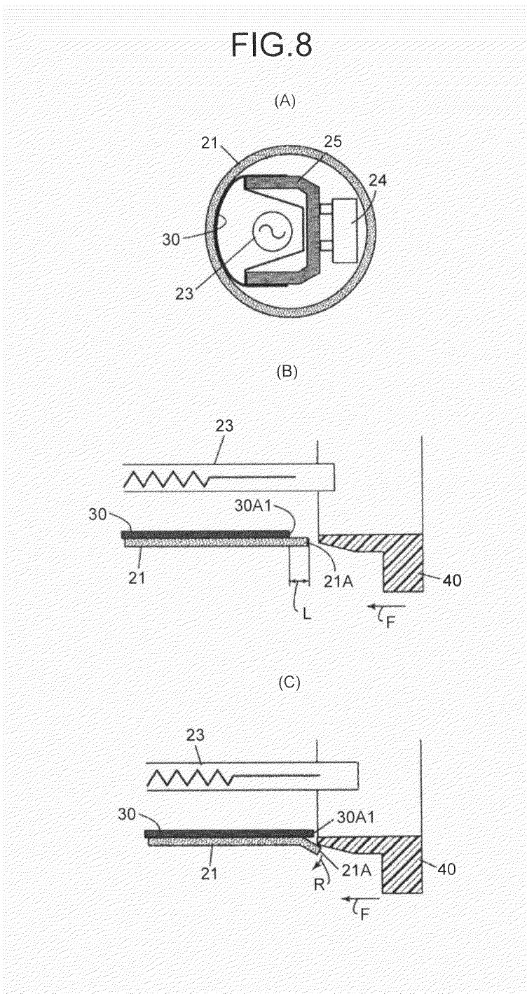

FIG. 11 illustrates a procedure for assembling a fixing member onto holding members;

FIG. 12 illustrates the fixing member and the holding member in a conventional assembled state;

FIG. 13 illustrates a disadvantage of the configuration illustrated in FIG. 12;

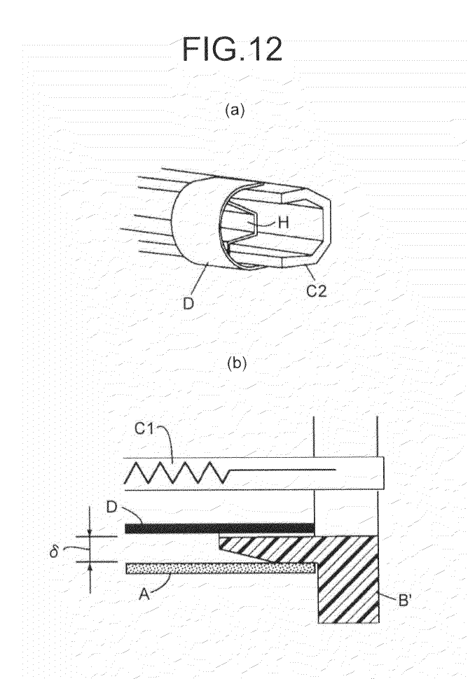

FIG. 14 is a perspective view illustrating the fixing belt illustrated in (d) in FIG. 11 to which the holding member is not inserted yet; and

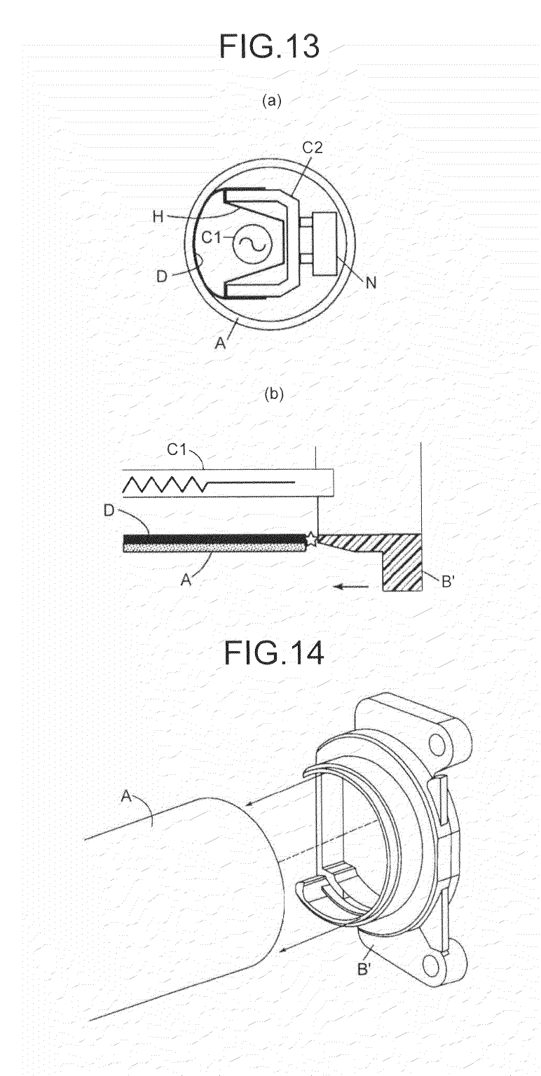

FIG. 15 is a perspective view illustrating the fixing belt illustrated in (e) in FIG. 11 with the holding member inserted therein.

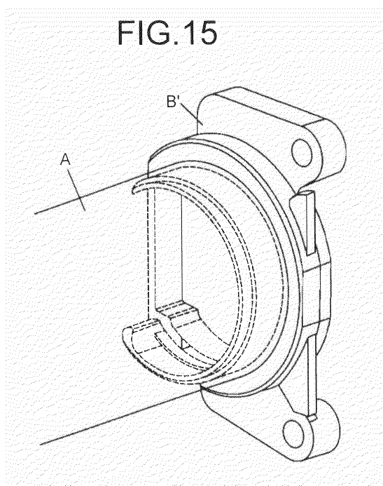

### DETAILED DESCRIPTION OF THE PREFERRED EMBODIMENTS

Exemplary embodiments of the present invention are described below with reference to the accompanying drawings.

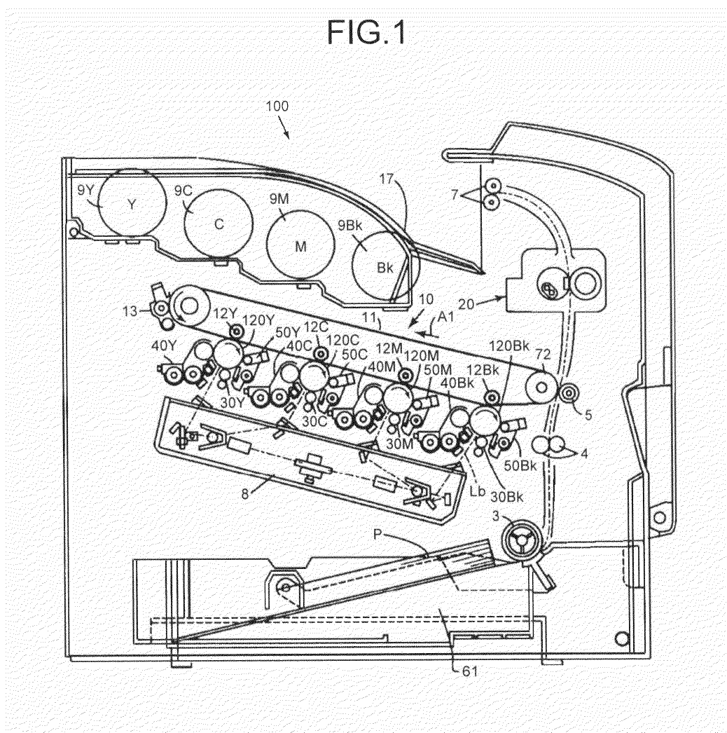

The image forming apparatus illustrated in FIG. 1 is a color printer capable forming a multiple-color image. Note that image forming apparatuses of the embodiments of the present invention are not limited printers but can include copiers, facsimiles, printing machines, and multifunction peripherals having two or more functions of these.

An image forming apparatus 100 adopts a tandem structure in which photoconductor drums 120Y, 120C, 120M, and 120Bk which are image bearers capable of forming color-separated images or, more specifically, an image of yellow, that of cyan, that of magenta, and that of black, respectively, are arranged in a row.

The image forming apparatus 100 performs a transfer process of transferring visible images formed on the photoconductor drums 120Y, 120C, 120M, and 120Bk one image by one image onto a transfer belt 11 which is configured to revolve in a direction indicated by arrow A1 while facing the photoconductor drums 120Y, 120C, 120M, and 120Bk. In this transfer process corresponding to a primary transfer process, images transferred one image by one image onto the transfer belt 11 form superimposed transferred images.

Thereafter, a secondary transfer process is performed to collectively transfer the superimposed transferred images onto recording paper P which can be a recording sheet, for example.

Devices for applying an image forming process on the rotating photoconductor drums 120Y, 120C, 120M, and 120Bk are arranged around the photoconductor drums 120Y, 120C, 120M, and 120Bk. The image forming process is described more specifically below by way of an example of the photoconductor drum 120Bk which forms a black image.

A charging device 30Bk, a developing device 40Bk, a primary transfer roller 12Bk, and a cleaning device 50Bk which apply the image forming process are arranged along the rotating direction of the photoconductor drum 120Bk. Writing, which is performed after charging, is performed using an optical scanning device 8 which will be described later.

Superimposing transfer onto the transfer belt 11 is performed by transferring visible images formed on the respective photoconductor drums 120Y, 120C, 120M, and 120Bk one image by one image onto the transfer belt 11 that is revolved in the direction indicated by the arrow A1 so that the images are superimposed on one another. The primary transfer process is performed by applying a transfer bias on a per-image basis from upstream to downstream in the direction indicated by the arrow A1 using primary transfer rollers 12Y, 12C, 12M, and 12Bk disposed to face the photoconductor drums 120Y, 120C, 120M, and 120Bk with the transfer belt 11 therebetween.

The photoconductor drums 120Y, 120C, 120M, and 120Bk are housed in a process cartridge as being arranged in this order from upstream to downstream in the direction indicated by the arrow A1.

The photoconductor drums 120Y, 120C, 120M, and 120Bk include an image station for forming a yellow image, that for forming a cyan image, that for forming a magenta image, and that for forming a black image, respectively.

As a structure that performs the primary transfer process, a transfer belt unit 10 including the transfer belt 11 and the primary transfer rollers 12Y, 12C, 12M, and 12Bk facing the photoconductor drums 120Y, 120C, 120M, and 120Bk with the transfer belt 11 therebetween is used.

The images transferred to and superimposed on the transfer belt 11 are collectively transferred onto the transfer paper P by a secondary transfer roller 5 which is a roller rotated by rotation of the transfer belt 11.

The image forming apparatus 100 includes, in addition to the process cartridge and the transfer belt unit 10 described above, the optical scanning device 8 serving as the optical writing device, and a cleaning device 13 for the transfer belt 11. The optical scanning device 8 is arranged to face the four image stations from below.

The optical scanning device 8 includes semiconductor lasers serving as a light source, coupling lenses, fθ lenses, toroidal lenses, mirrors, and a rotating polygon mirror.

The optical scanning device 8 emits writing beams Lb, each corresponding to one of the colors, onto the photoconductor drums 120Y, 120C, 120M, and 120Bk. Although only the image station for black images is indicated with reference numerals for convenience in FIG. 1, the same applies to the other image stations. Electrostatic latent images are formed on the photoconductor drums 120Y, 120C, 120M, and 120Bk with this configuration.

The image forming apparatus 100 includes a sheet feeding device 61 and a pair of registration rollers 4.

The sheet feeding device 61 delivers a sheet of the recording paper P onto which the superimposed transferred images are collectively transferred in the secondary transfer process. The pair of registration rollers 4 delivers the transfer paper P delivered from the sheet feeding device 61 to a secondary transfer position while adjusting registration timing. The image forming apparatus 100 further includes a sensor (not shown) for detecting that the leading end of the transfer paper P has reached the pair of registration rollers 4.

The recording paper P onto which the toner images, which have been transferred to and superimposed on the transfer belt 11, are collectively transferred as a single toner image in the secondary transfer process is conveyed to a fixing device 20 where the toner image is fixed. The fixing device 20 will be described later. The transfer paper P onto which the toner image is fixed is ejected via sheet ejection rollers 7 to a sheet ejection tray 17 arranged outside body of the image forming apparatus 100. Each of the image stations includes one, of a corresponding color, of toner supply tanks 9Y, 9C, 9M, and 9Bk for replenishing a corresponding one of the developing devices with toner.

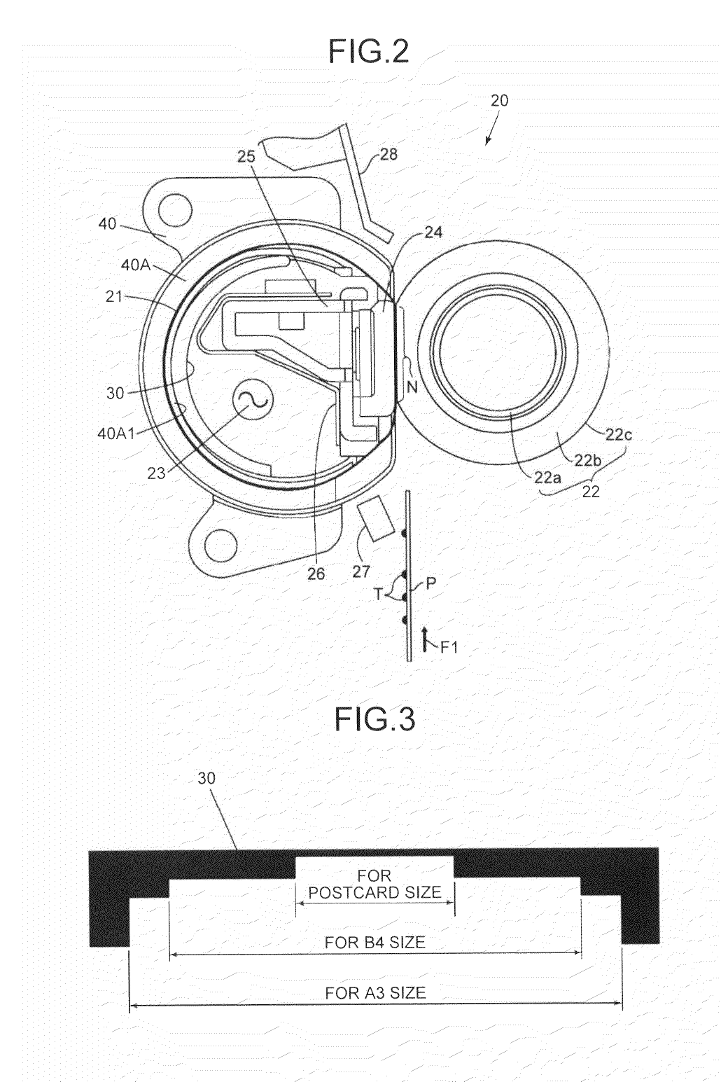

As illustrated in FIG. 2, the fixing device 20 according to the embodiment employs a configuration which uses an endless fixing belt 21 as a fixing member to be heated by a heat source. The configuration of the fixing device 20 is described below.

The fixing device 20 includes the flexible fixing belt 21 configured to be revolvable while being heated. The fixing belt 21 is used to fix a toner image T transferred to and borne on the recording paper P by fusing and causing the toner image T to permeate through the recording paper P with heat and a pressure.

The fixing device 20 includes, in addition to the fixing belt 21, a pressing roller 22 which is a counter rotator configured to be rotatable while facing the fixing belt 21. The pressing roller 22 is used to form the nip area N between the pressing roller 22 and the fixing belt 21 by applying a pressure to the fixing belt 21. The fixing device 20 further includes a heater 23 including a halogen lamp as a heat source for heating a site other than the nip area N. In the embodiment, the site is an area on the revolving fixing belt 21 on the side opposite from the nip area N.

A nip forming member 24, a stay 25, and a reflecting member 26 are arranged on the internal side of the fixing belt 21. The nip forming member 24 is a nip-forming base member. The stay 25 supports the nip forming member 24. The reflecting member 26 reflects light radiated from the heater 23 toward the fixing belt 21.

Although details of the nip forming member 24 which is the nip-forming base member are not illustrated, the nip forming member 24 includes, as a member to be brought into contact with the fixing belt 21, a sliding sheet (low-friction sheet) wound around a base pad.

The nip forming member 24 illustrated in FIG. 2 forms the nip area N having a flat profile. However, the profile of the nip area N is not limited thereto. For example, the nip area N may be formed along the circumferential surface of the pressing roller 22 to have a concaved profile. This profile is advantageous in that because the leading end of the recording paper P passing through the nip area N leans toward the pressing roller 22, the recording paper P is separated from the fixing belt 21 more reliably.

The temperature of the fixing belt 21 is detected by a temperature sensor 27 arranged on the side from which the recording paper P enters the nip area and used in feedback processing of the heater 23. Arrow F1 of FIG. 2 indicates a conveying direction of the recording paper P.

The fixing belt 21 is a thin, flexible endless belt formed in the shape of a sleeve. The fixing belt 21 includes a base material and a release layer provided on the surface of the base material.

The base material may be made of a metal material such as nickel or stainless steel, or a resin material such as polyimide. The releasing layer may be made of a material having toner releasability, such as tetrafluoroethylene-perfluoroalkyl vinyl ether copolymer (PFA) or polytetrafluoroethylene (PTFE).

The pressing roller 22 includes a cored bar 22a, an elastic layer 22b disposed on the surface of the cored bar 22a, and a release layer 22c disposed on the surface of the elastic layer 22b. The elastic layer 22b is made of solid or foamed silicone rubber, fluororubber, or the like. The release layer 22c is made of PFA, PTFE, or the like. The pressing roller 22 is pressed by urging means (not shown) toward the fixing belt 21 into contact with the nip forming member 24, which is the base member in contact with the fixing belt 21, with the fixing belt 21 therebetween.

At a portion where the pressing roller 22 and the fixing belt 21 contact each other, the elastic layer 22b of the pressing roller 22 is compressed. As a result, a pressure is applied to the nip forming member 24, whereby the nip area N having a predetermined width is formed between the pressing roller 22 and the fixing belt 21.

The pressing roller 22 is configured to be driven to rotate by a drive source (not shown) such as a motor disposed on the printer body. The fixing device 20 is configured so that when the pressing roller 22 is driven to rotate, the driving force is transmitted to the fixing belt 21 at the nip area N, and the fixing belt 21 is revolved by rotation of the pressing roller 22.

In the configuration illustrated in FIG. 2, the pressing roller 22 is a solid roller. Alternatively, the pressing roller 22 may be a hollow roller. In a configuration where the pressure roller 22 is a hollow roller, a heating source such as a halogen heater which uses radiant heat can be arranged inside the pressing roller 22. The pressing roller 22 may be configured without the elastic layer 22b. In this case, heat capacity is increased, and fixability (toner fixing onto recording paper) is enhanced; however, minute asperities of the surface of the belt can be transferred onto an image when fixing not-yet-fixed toner by compressing the toner. As a result, solid portions of the image can have an uneven gloss. To prevent such uneven gloss, it is desirable that the pressing roller 22 includes an elastic layer whose thickness is 100 μm or larger. Examples of the material of a metal pipe, of which the hollow roller is made, include aluminum, iron, and stainless steel. When the configuration in which a heat source is arranged inside the pressing roller 22, it is desirable to provide a heat insulation layer on the surface of a substrate or to provide a heat-ray reflection surface, to which mirror-surface finishing is applied, to prevent the substrate from being heated by radiant heat from the heat source. The heat source in this configuration is not limited to the halogen heater described above. An IH (induction heating) heater, a resistance heating element, or a carbon heater can be used as the heat source.

A separating-and-conveying mechanism 28 is arranged at an exit of recording paper from the fixing device 20. The separating-and-conveying mechanism 28 separates the recording paper P passing through the nip area at a position near the nip area and directs the recording paper P in an ejecting direction toward the sheet ejection tray 17 (see FIG. 1).

The fixing device 20 includes a shield member 30 as a member that prevents an excessive temperature rise in a non-sheet conveying area, which is a part of a heating area to be heated by the heater 23 of the fixing belt 21, in a sheet width direction. The shield member 30 partially shields heat from the heater 23 in the sheet width direction. The sheet width direction is the direction perpendicular to the plane of FIG. 2, parallel to the width direction of the fixing belt 21, and perpendicular to the revolving direction of the fixing belt 21.

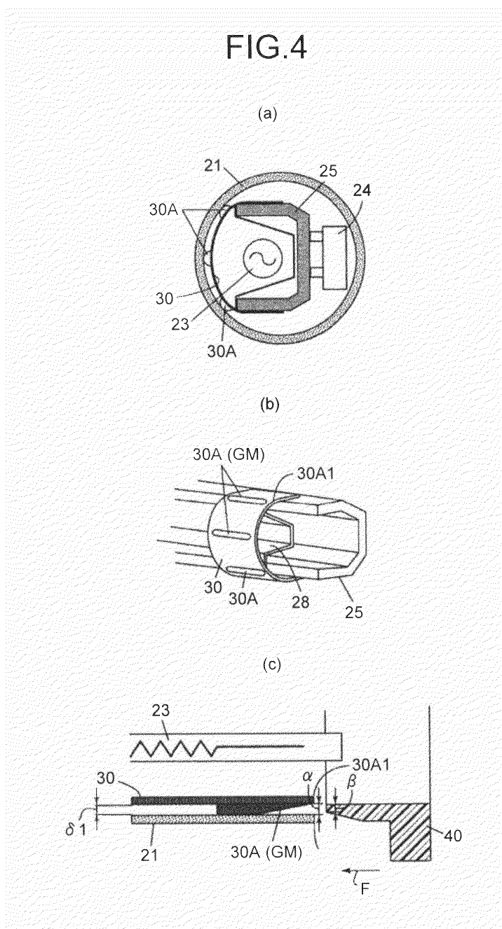

The shield member 30 is shaped to provide different light-shielding areas accommodated to different width sizes of sheets conveyed through the fixing device 20. For example, as illustrated in FIG. 3, the shield member 30 may have a stepped profile providing opening areas of different widths (e.g., the postcard size, the B4 size, and the A3 size) of sheets conveyed through the fixing device 20. Note that the shield member 30 is configured to have large shielding areas at ends in the width direction (hereinafter, “width ends”) which belong to a non-sheet conveying area in many cases. The lateral direction of FIG. 3 is the sheet width direction described above. The longitudinal direction of the shield member 30 extending in the sheet width direction is the sheet width direction.

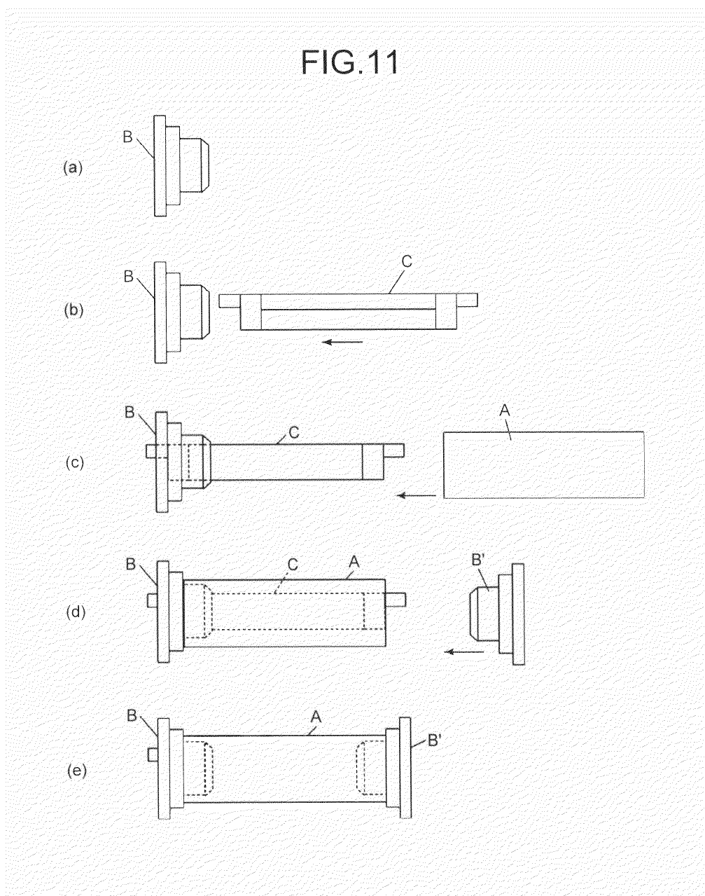

As illustrated in FIG. 2, an end of a boss portion 40A of a holding member 40 mounted on each of width ends of the fixing belt 21 is inserted to the shield member 30, thereby arranging the shield member 30 with a clearance 51, which is similar to the clearance 5 described earlier with reference to (b) in FIG. 12, between the shield member 30 and the fixing belt 21.

Although details are not illustrated, the shield member 30 illustrated in FIG. 3 is a member for shielding, in a configuration where the heater 23 includes a plurality of heater wires having different heating areas for different sheet sizes in the longitudinal direction, heat from heater wires other than a selected heater wire(s). For this purpose, the shield member 30 has the profile providing the different opening areas and is fixed near the heater wires.

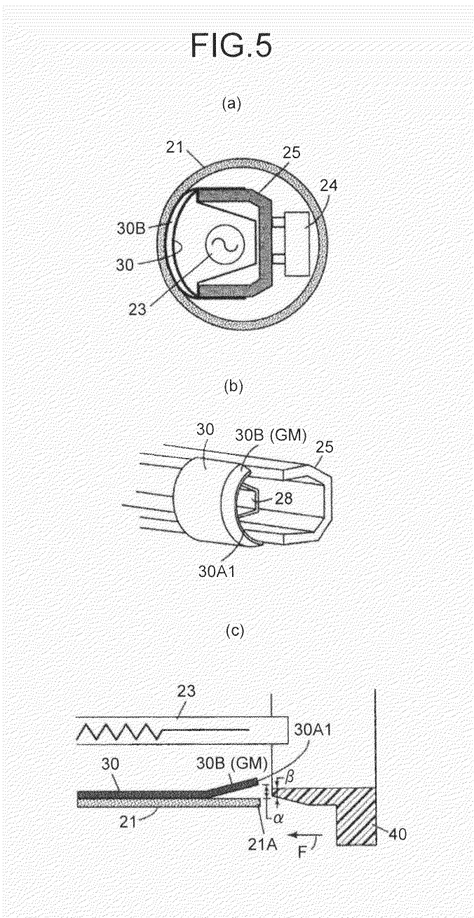

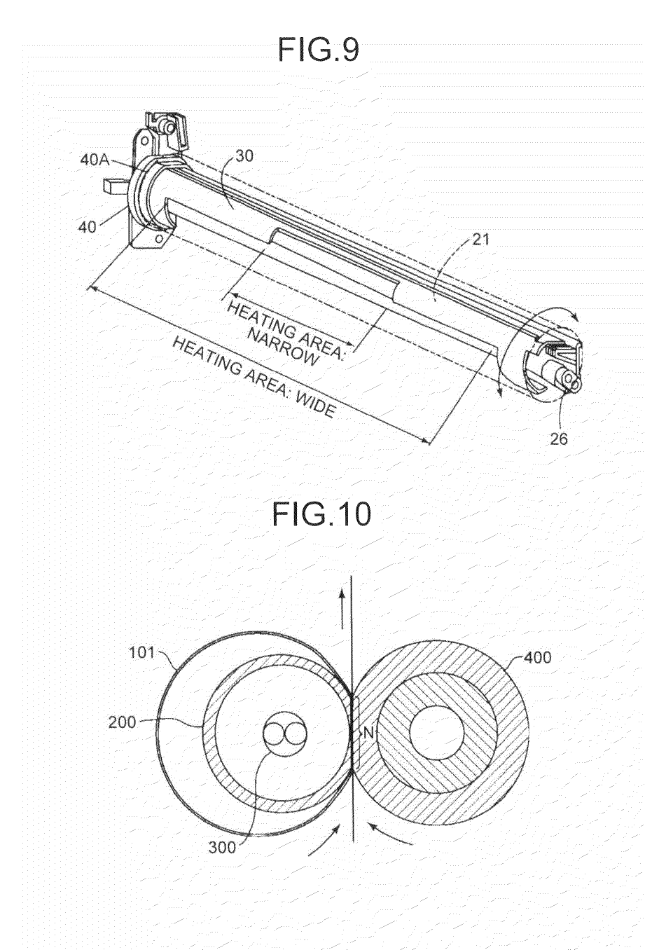

In the fixing device 20 having the above-described configuration, the holding members 40 are mounted on the opposite ends of the fixing belt 21 through a procedure similar to that described with reference to (a) to (e) in FIG. 11. The fixing device 20 includes a spacer GM, which will be described below with reference to FIGS. 4 to 6, as a structure for avoiding a colliding contact between the holding member 40 and a width end of the fixing belt 21 when the holding member 40 is assembled onto the fixing belt 21.

More specifically, the shield member 30 includes the spacer GM on at least one of longitudinal end portions 30A1 of the shield member 30. The spacer GM defines, when the holding member 40 is inserted, a clearance that allows insertion of the holding member 40 between the shield member 30 and an internal side of an end portion 21A, which corresponds to the end portion 30A1, of the fixing belt 21. A structure of the spacer GM is described below.

As illustrated in FIG. 4, the spacer GM includes a plurality of protrusions 30A protruding toward the internal side of the end portion 21A of the fixing belt 21.

As illustrated in (a) and (b) in FIG. 4, the plurality of protrusions 30A formed on the surface of the end portion 30A1 of the shield member 30 facing the end portion 21A of the fixing belt 21 are circumferentially arranged.

As illustrated in (c) in FIG. 4, the protrusion 30A includes an inclined surface serving as an insertion guide on the side where the holding member 40 is to be inserted. The protrusion 30A is configured so that a maximum height α of space between the inclined surface and the fixing belt 21 provides the clearance δ1 similar to the clearance δ described earlier with reference to FIG. 12. The height α is larger than a thickness β of an end portion on the insertion side (hereinafter, “insertion-side end portion”) of the holding member 40 as illustrated in (c) in FIG. 4.

In this structure, because the protrusions 30A serving as the spacer GM are provided between the fixing belt 21 and the shield member 30, the clearance 51 that allows insertion of the holding member 40 is defined in advance. Accordingly, by contrast to a structure where the end portion 21 of the fixing belt 21 and the end portion 30A1 of the shield member 30 overlap each other, the holding member 40 can be inserted into the clearance. As a result, the holding member 40 is less likely to come into a colliding contact with the end portion 21 of the fixing belt 21.

The structure of the spacer GM is not limited to that described above.

For example, as illustrated in FIG. 5, the spacer GM may have a slope 30B inclined in such a manner that the distance between the slope 30B and the internal side of the end portion 21A of the fixing belt 21 increases in a direction from the width center toward the outer end of the fixing belt 21.

With this structure, size of the clearance that allows insertion of the holding member 40 can be selected by making use of the slope angle of the slope 30B. The larger the slope angle, the wider the clearance that allows insertion of the holding member 40 and, accordingly, insertion of the holding member 40 is facilitated.

In this structure, as in the structure illustrated in FIG. 4, the clearance that allows insertion of the holding member 40 is defined in advance. As a result, the holding member 40 is less likely to come into a colliding contact with the end portion of the fixing belt 21.

Still another structure of the spacer GM is described below with reference to FIG. 6.

As illustrated in FIG. 6, the spacer GM includes, at the end portion 31A of the shield member 30, a stepped portion 30C that is smaller in diameter than a portion of the fixing belt 21 on a side of the width center of the fixing belt 21. The depth of the stepped portion 30C is slightly larger than the thickness of the insertion-side end portion of the holding member 40 as in the structure illustrated in FIG. 4.

As illustrated in (c) in FIG. 6, the stepped portion 30C has a sloped elevation surface connecting between a surface corresponding to a lower step and a surface corresponding to an upper step. The stepped portion 30C is configured so that when the holding member 40 abuts on the stepped portion 30C, the lower step is separated from the fixing belt 21, thereby allowing the holding member 40 to enter between the lower step and the fixing belt 21.

Also in this structure, as in the structure illustrated in FIGS. 4 to 5, the clearance that allows insertion of the holding member 40 is defined in advance. As a result, the holding member 40 is less likely to come into a colliding contact with the end portion 21A of the fixing belt 21.

Each of the structures described above is not necessarily employed singly. Put another way, any two or more of the structures described above can be combined together.

For instance, applying the protrusions 30A illustrated in FIG. 4 to the slope 30B illustrated in FIG. 5 can increase the displacement travel of the shield member 30 at insertion of the holding member 40 as compared with the structure to which only the protrusions 30A are applied or that to which only the slope 30B is applied. As a result, time it takes to define the small clearance δ1 between the fixing belt 21 and the shield member 30 can be reduced.

The structure of the spacer GM is not limited to those described above in which the spacer GM is provided by modifying the shield member 30.

For instance, a configuration in which at least one edge of the edges of the shield member 30 is positionally displaced from a corresponding at least one edge, which corresponds to the edge of the shield member 30, of the fixing belt 21.

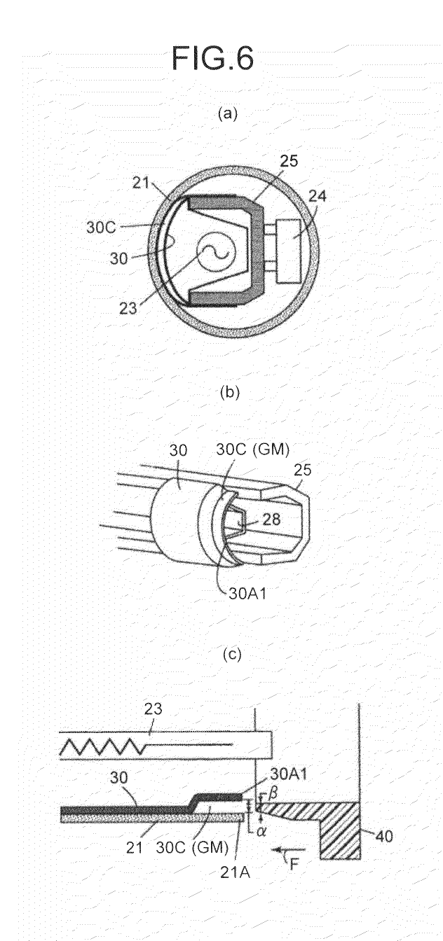

FIG. 7 illustrates examples in which the position of the edge of the shield member 30 in the width direction is defined in advance, and the corresponding edge of the fixing belt 21 is positionally displaced from the edge of the shield member 30.

Referring to FIG. 7 illustrating the fixing belt 21 and the shield member 30 on the side where the holding member is inserted, the position of the edge 21A of the fixing belt 21 is displaced by the distance indicated by L toward the width center with respect to the edge 30A1 of the shield member 30.

This configuration provides a movable area that allows the insertion-side end portion of the holding member 40 to push and tilt the edge 30A1 of the shield member 30 projecting outward than the edge 21A of the fixing belt 21 when the holding member 40 is inserted (by being moved in the direction indicated by arrow F). Accordingly, when the holding member 40 is inserted, the movable area tilts (by moving in the direction indicated by arrow R), thereby providing a clearance that allows insertion of the holding member 40 between the fixing belt 21 and the shield member 30. More specifically, by being pushed and tilted by the holding member 40, the edge 30A1 of the shield member 30 is separated from the internal side of the fixing belt 21, thereby providing the clearance that allows insertion of the holding member 40 between the fixing belt 21 and the shield member 30. The clearance for insertion in this configuration differs from the clearances of the structures illustrated in FIGS. 4 to 5 in that the clearance depends on how far the holding member 40 is pushed. For example, when the holding member 40 is pushed a large distance, a large clearance is provided.

Thus, the configuration provides the clearance that allows insertion of the holding member 40 before the holding member 40 abuts on the edge 21A on the side, at which the holding member is inserted, of the fixing belt 21, thereby avoiding a colliding contact between the fixing belt 21 and the holding member 40.

With this configuration, an area where the shield member 30 shields heat from the heat source can extend outward than the width end of the fixing belt 21. Accordingly, an excessive temperature rise in the non-sheet conveying area of the fixing belt 21 can be prevented reliably by shielding heat leakage from the width end.

FIG. 8 illustrates examples in which, in contrast to the configuration illustrated in FIG. 7, the edge of the shield member 30 corresponding to the edge, whose position in the width direction is defined in advance, of the fixing belt 21 is positionally displaced from the edge of the fixing belt 21.

Referring to FIG. 8 which illustrates the fixing belt 21 facing the side where the holding member 40 is inserted and the edge 30A1 of the shield member 30, the position of the edge 30A1 of the shield member 30 is displaced by the distance indicated by L toward the width center with respect to the edge 21A of the fixing belt 21.

In this configuration, as in the configuration illustrated in FIG. 7, when the holding member 40 is inserted to the end portion of the fixing belt 21, the fixing belt 21 is pushed (in a manner to move in the direction indicated by the arrow R) by the holding member 40, thereby providing a clearance that allows the insertion-side end portion of the holding member 40 to enter between the fixing belt 21 and the shield member 30.

In this configuration, the edge 21A of the fixing belt 21 is more exposed than that of the shield member 30 to the side where the holding member is inserted. Therefore, the position where the holding member 40 inserted or, put another way, the position of the edge of the fixing belt 21, can be viewed more easily. Accordingly, because the holding member 40 can be inserted while visually sighting the position of the edge of the fixing belt 21, avoiding a colliding contact between the holding member 40 and the fixing belt 21 is facilitated as compared with a configuration where the position of the edge of the fixing belt 21 is less easily visually sighted. As a matter of course, in this configuration, the edge 30A of the shield member 30 on the side where the holding member 40 is inserted is to be positioned so as not to hinder preventing an excessive temperature rise in the non-sheet conveying area.

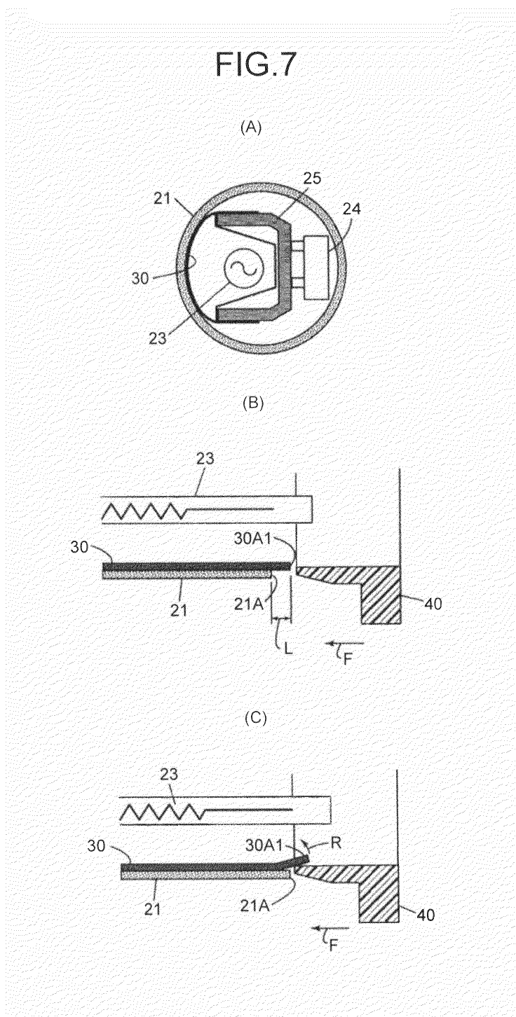

The shield member is not limited to such a fixed type as that described above with reference to FIG. 3. The shield member 30 may be configured to be movable in the revolving direction of the fixing belt 21 as illustrated in FIG. 9. With this configuration, it is preferable that the shield member 30 moves in a manner that causes an opening area, which varies depending on a sheet size, to face the fixing belt 21, thereby shielding heat from a heater having a single heat source differently in accordance with a condition such as the size.

According to an aspect of the present invention, a clearance shape portion provides a clearance that allows insertion of a holding member between an end portion of a fixing member and a shield member. Accordingly, a damage that would otherwise be given to the fixing member when mounting the holding member can be prevented or at least reduced.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A fixing device comprising:
a fixing member configured to be revolvable while being heated by a heat source;
a counter rotator configured to form a nip between the fixing member and the counter rotator by applying a pressure to the fixing member in a contact state with the fixing member;
a shield member disposed inside the fixing member to partially shield heat from the heat source; and
a holding member attached to an end of the fixing member, wherein
the shield member includes a spacer configured to define a clearance to allow the holding member to be inserted into the fixing member from an end of the fixing member, the clearance being between the shield member and an inner surface of the end of the fixing member.

2. The fixing device according to claim 1, wherein the spacer includes a protrusion protruding toward an inner surface of the fixing member.

3. The fixing device according to claim 1, wherein the spacer includes a slope that the closer to the end of the fixing member the slope, the lower a height of the slope, the slope inclining away from the inner surface of the fixing member.

4. The fixing device according to claim 1, wherein the spacer includes a stepped portion disposed closer to the end of the fixing member, the stepped portion being smaller in diameter than other portions of the spacer.

5. An image forming apparatus comprising the fixing device according to claim 1 to fix a toner image borne on a recording sheet.

6. A fixing device comprising:
a fixing member configured to be revolvable while being heated by a heat source;
a counter rotator configured to form a nip between the fixing member and the counter rotator by applying a pressure to the fixing member in a contact state with the fixing member;
a shield member disposed inside the fixing member to partially shield heat from the heat source; and
a holding member attached to an end of the fixing member, wherein
an edge of the shield member closer to the end of the fixing member is shifted from an edge of the end of the fixing member in a longitudinal direction of the fixing member.

7. The fixing device according to claim 6, wherein the edge of the shield member is closer to a center of the fixing member in the longitudinal direction than the edge of the fixing member.

8. The fixing device according to claim 6, the edge of the fixing member is closer to a center of the fixing member in the longitudinal direction than the edge of the shield member.

9. An image forming apparatus comprising the fixing device according to claim 6 to fix a toner image borne on a recording sheet.
